(19) United States
(12) Patent Application Publication
(10) Pub. No.: US 2013/0199383 A1
(43) Pub. Date: Aug. 8, 2013

(54) HIGH COMPRESSION SHAFT CONFIGURATION AND RELATED METHOD FOR SCREW PRESS SYSTEMS USED IN RENDERING APPLICATIONS

(71) Applicants: Robert H. Horton, Springboro, OH (US); Donald A. Shaw, Springboro, OH (US); William H. Williams, Franklin, OH (US)

(72) Inventors: Robert H. Horton, Springboro, OH (US); Donald A. Shaw, Springboro, OH (US); William H. Williams, Franklin, OH (US)

(21) Appl. No.: 13/756,043

(22) Filed: Jan. 31, 2013

Related U.S. Application Data
(60) Provisional application No. 61/595,298, filed on Feb. 6, 2012.

(51) Int. Cl. B30B 9/12; B30B 9/14

(52) U.S. Cl. CPC B30B 9/121; B30B 9/14
USPC 100/37; 100/145; 100/117

(57) ABSTRACT

A rendering method involves heating the animal protein and thereafter feeding the heated animal protein through a rendering screw press machine having an internal shaft assembly that includes a working portion with an overall compression ratio of greater than about 7 to 1, a first scroll flight section configured for decreasing cake thickness, followed by a first high compression cone section, followed by a stepped decompression section, followed by a second scroll flight section configured for decreasing cake thickness, followed by a second high compression cone section, followed by a straight collar section. Rotating the shaft assembly moves the heated animal protein through the machine such that liquid fat passes out through a barrel cage and substantially dried animal protein cake is output from the choke opening, and the heated animal protein only undergoes one stepped decompression during such movement.

### CROSS-REFERENCES

This application claims the benefit of U.S. Provisional Application Ser. No. 61/595,298, filed Feb. 6, 2012.

### TECHNICAL FIELD

The present application relates generally to screw presses utilized for removing liquid fat from unpressed crax (cooked animal protein) produced in the rendering process and, more particularly, to a high compression shaft configuration and related screw press system and method.

### BACKGROUND

Referring to FIGS. 1 and 2, in a typical prior art rendering press 10, such as the Pressor® system available from The Dupps Company of Germantown, Ohio, the feed material enters the screw press through a feed hopper 12. The hopper cage 14 encloses the feed quill section 16 of the shaft. The feed quill 16 pushes material into the barrel cage section 18. Free liquid drains off the material through the cage. The main shaft section is a heavy duty screw conveyor (e.g., made up of multiple flight modules 20a-20g, that are disposed on a shaft 22 in a keyed manner, along with the feed quill 16, using key members 24a-24d) that rotates in the slotted barrel cage. The root diameter of the main shaft flights is tapered so it is larger near the discharge end 26 than at the feed end 28. The discharge end includes a straight nose collar module 26 that defines the final root diameter at the choke opening. The rotation of the main shaft conveys the material through the barrel cage toward the choke opening, where it is discharged as “cake”. A motor 30 and gearbox 32 for driving the shaft are also shown.

Referring to FIGS. 3 and 4, a typical 4′ long barrel cage consists of four rows or axial sections 32a-32d of ½″ long×½″ wide×1.25″ deep (i.e., radial depth) barrel bars 34 tightly spaced and disposed annularly (e.g., using spacers 36 between the bars and wedge bars 38 at the top and bottom of each half of the barrel bar cage adjacent the knife bars 40 and pressure bars 42) to allow the oil to escape and to at the same time retain the majority of the solid material. The knife bars 40a-40c prevent the material from turning with the shaft and re-orient the material to promote fat separation.

Referring to FIG. 5, a prior art Dupps 12-10-4 Pressor® system has a shaft 50 with a 12″ diameter feed quill 52 and a 10″ diameter main shaft section 54 made up of multiple flight members, used in a machine with a 4′ long main cage (not shown). Per FIG. 6, the prior art Dupps 12-12-4 Pressor® system has a shaft 60 with a 12″ diameter feed quill and a 12″ diameter main shaft section 62 made up of multiple flight members, used in a 4′ long main cage (not shown). These traditional rendering shafts have length to diameter (L/D) ratios ranging from between about 4 to 1 and about 5 to 1 and compression ratios that range from about 4:1 to about 5:1. The shafts include scroll flights that decrease cake thickness by increasing flight body diameter. The final cake thickness produced by such traditional rendering shafts is typically around ¾″. The barrel cages used on rendering presses are typically 4′ long and consist of four rows 12″ long×½″ wide×1.25″ deep barrel bars tightly spaced.

Referring to FIG. 7, traditional oilseed shafts such as illustrated shaft 70 have length to diameter ratios ranging from 6 to 1 and about 7.2 to 1 and compression ratios in excess of 7:1. Traditional oilseed shafts consist of scroll flights and cone flights, such as cone flights 72, 74 and 76 having scroll flights therebetween. The final cake thickness produced by traditional oilseed shafts is typically around 3/8″. Barrel cages used on oilseed presses are typically 6′ long and consist of six rows 12″ long×3/8″ wide×1.25″ deep precision ground barrel bars that are very tightly spaced. Thus, use of the oilseed shaft in a typical rendering press with a four foot long cage is not possible.

U.S. Pat. No. 4,915,830 discloses a pulp wash press in which the pulp is first compressed, then decompressed and mixed with the injection of a wash liquid, and then compressed again. However, this patent is not for use in rendering applications in which the removal of fat from cooked animal byproduct is desired, and adding washing liquid is contrary to efficient fat removal and subsequent processing.

U.S. Pat. No. 4,764,464 discloses a parallel shaft device and related process for extracting fat from an animal material. The process includes the use of a melting zone B with surrounding heaters in which progressive heating occurs along with kneading and pressure increase, with a sudden expansion to facilitate evaporation of the steam. In a downstream extraction zone C the material is subjected to increasing pressure (using eccentric kneading discs) capable of separating the melted fat, which is discharged via filtering walls. The extraction zone itself does not utilize compression, followed by expansion, followed again by further compression.

U.S. Patent Publication No. 2004/0182260 discloses a rendering screw press and method in which a frusto conical member 200 with circumferential recesses 204 at its large diameter end is used to compress the process material and then decompress and mix the process material. The method as described in this patent publication does not utilize a second frusto conical member downstream of member 200 and no detail is provided as to what degree of compression and decompression is effective to enhance liquid extraction.

In practice, Haarslev Industries has implemented a longer (i.e., for use with a six foot long barrel cage) and larger diameter (i.e., larger than twelve inches in the cage section) rendering screw shaft with three frusto-conical members spaced apart from each other, each followed by a step down for decompression. However, the Haarslev machine operates at a lower RPM than the Dupps machine and the Haarslev screw arrangement cannot be used in the standard Dupps pressor with a four foot long barrel cage. It is not practical to use three step downs in the shorter cage machine.

With the ever increasing price of liquid fats in the marketplace, it would be desirable to provide an improved screw press shaft, system and method that increases the extraction rate of liquid fats without adversely affecting material throughput.

### SUMMARY

The device and method of the present application is able to maintain the traditional rendering shaft L/D ratio and decrease the fat residual in the meal by an additional 1%-2%. The resulting shaft configuration is a High Compression Press Release (HCPR™) shaft.

The high compression press release shaft may be used in conjunction with a 4′ long main barrel cage with barrel bars in a variety of possible configurations and a set of knife bars.

If the compression ratio of a press shaft is increased by using traditional rendering scroll flights at a constant press speed, the meal fat residual will theoretically decrease; however, throughput will also decrease. By contrast, the high compression press release shaft, producing a final cake thickness of about 3/8″, has a compression ratio greater than about 7:1, which reduces the fat residual in the meal by about an additional 1%-2% and maintains the press throughput, when compared to a traditional rendering shaft with about a 4.25:1 compression ratio at the same press speed.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a side elevation of a typical prior art rendering press arrangement;

FIG. 2 is an exploded view of a prior art rendering screw shaft utilized in the press of FIG. 1;

FIG. 3 is an exploded view of the barrel cage of the press of FIG. 1;

FIG. 4 is an end view of an assembled barrel cage according to FIG. 3;

FIG. 5 is a side elevation of one embodiment of a prior art rendering press shaft;

FIG. 6 is a side elevation of another embodiment of a prior art rendering press shaft;

FIG. 7 is a side elevation of one embodiment of a prior art oilseed press shaft;

FIG. 8 is a side elevation of a 12-10-4 high compression press release shaft embodiment;

FIG. 9 is a side elevation of a 12-12-4 high compression press release shaft embodiment;

FIG. 10 is a graph showing volume reduction for the shaft of FIG. 8; and

FIG. 11 is a graph showing volume reduction for the shaft of FIG. 9.

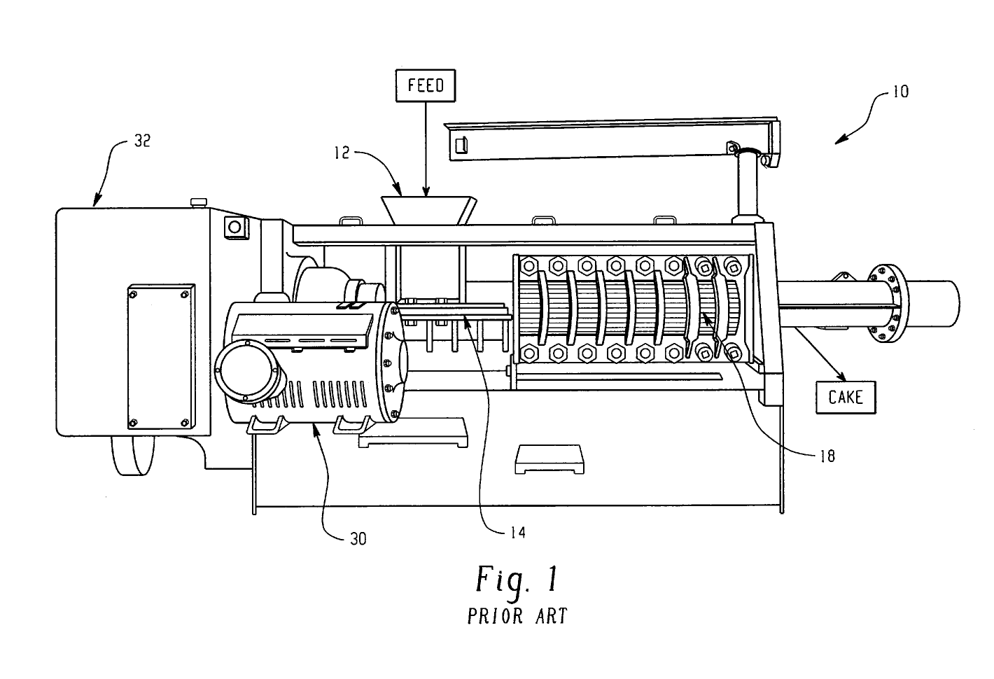

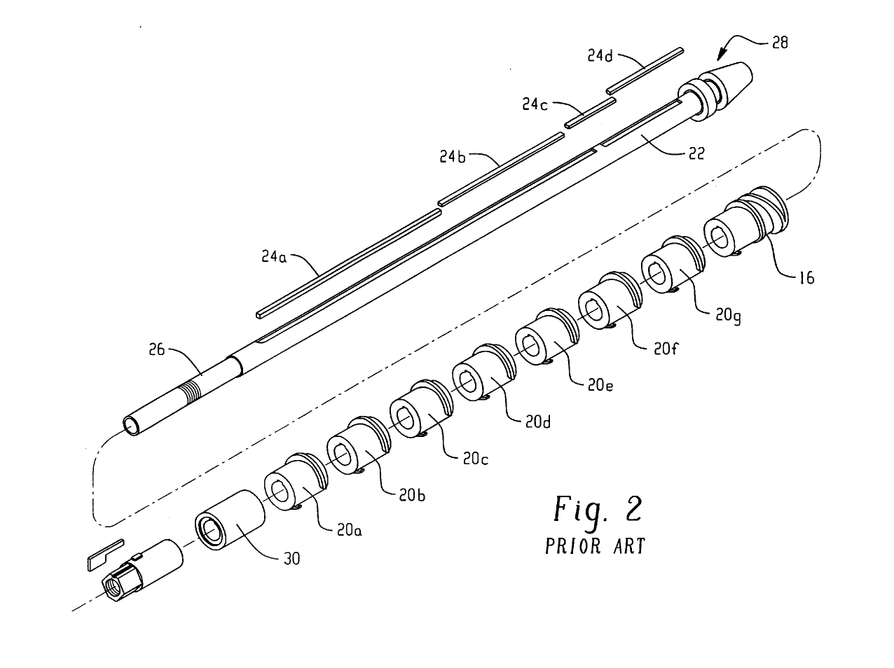

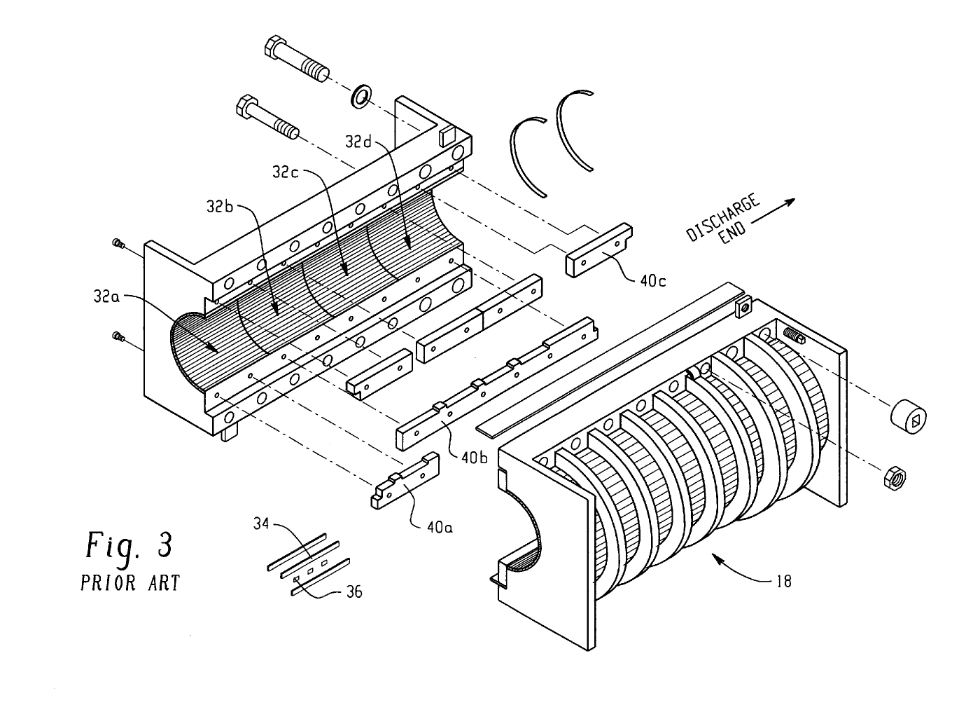

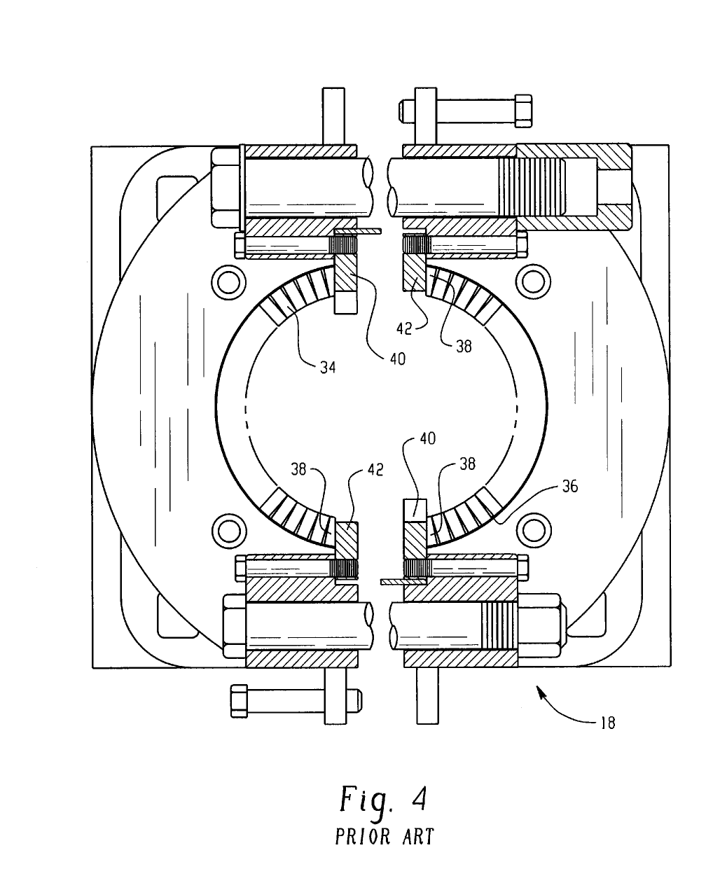

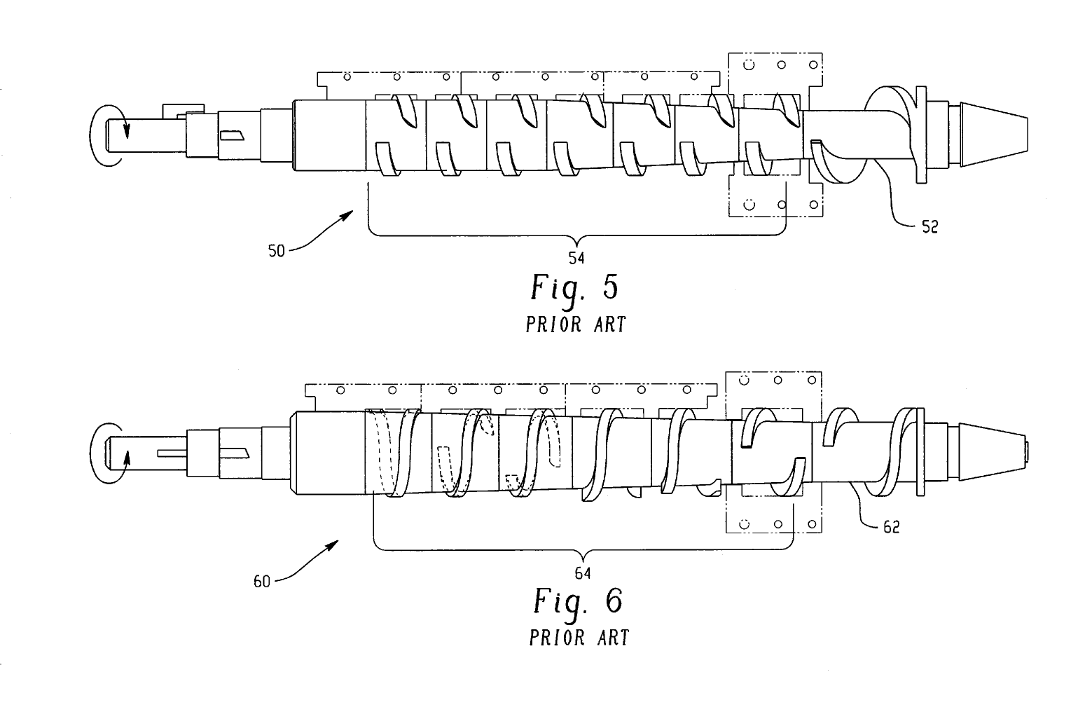

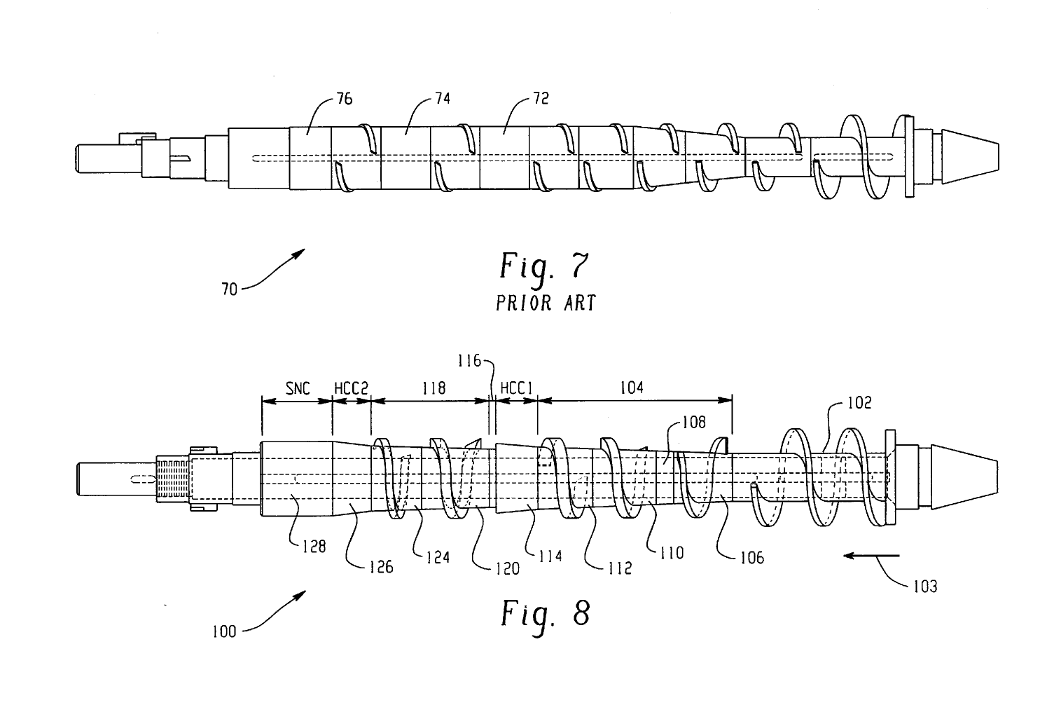

### DETAILED DESCRIPTION

Two primary embodiments of improved rendering press shafts in accordance with this application are described below, namely a 12-10-4 high compression press release shaft configuration and a 12-12-4 high compression press release shaft configuration.

### The 12-10-4 Shaft Configuration

Referring to the exemplary 12-10-4 shaft 100 shown in FIG. 8, a 12″ diameter, half pitch tapered feed quill 102 is utilized. The first approximately 60% of the shaft is configured like a traditional rendering shaft with scroll flights that gradually decrease the cake thickness from approximately 2″ to 1″ by gradually increasing the flight's body diameter. This first section is important because it gradually compresses the cooked material to form a hardened plug, which doesn't extrude through the barrel bars, when it contacts the first high compression cone. Material flow direction during rotation of the shaft is right to left in FIG. 8 as shown by arrow 103.

By way of example, a first scroll flight section 104 is made up of flight member 106, spacer 108, flight member 110 and flight member 112. This first scroll flight section is configured for decreasing cake thickness by at least about 40% (e.g., between about 45%-55%) over an axial length of between about 20 inches to about 30 inches (e.g., between about 24 inches to about 26 inches) with a compression ratio of between about 2.2 to 1 and about 2.6 to 1 (e.g., between about 2.4 to 1 and about 2.5 to 1). A first high compression cone section HCC1, made up of cone member 114, is adjacent and downstream of the first scroll flight section 104. The first high compression cone section HCC1 defines a compression ratio of between about 1.2 to 1 and about 1.3 to 1 along a length of no more than about seven inches (e.g., no more than about six inches (e.g. between about five and five and one-quarter inches (e.g., about five and one-eighth inches))). The material is abruptly decompressed (with a decompression ratio of at least about 1.5:1 (e.g., between about 1.6 to 1 and about 1.75 to 1)) at a stepped decompression section 116 that is adjacent and downstream of the cone and this pressure release is important, because it re-orients the material, so that further material compression will release more fat. The stepped decompression section 116 may be defined by a reduced diameter portion 122 formed integral with the cone member 114.

The cake then travels over a second scroll flight section 118 that includes flight member 120 and flight member 124. In the second scroll flight section 118 the pressure is gradually increased (prior to a second high compression cone section HCC2) with a compression ratio of between about 1.7 to 1 and about 2.0 to 1 (e.g, between about 1.8 to 1 and about 1.9 to 1). At the second cone section HCC2 formed by cone member 126 the pressure is increased with a compression ratio of between about 2.2 to 1 and about 2.6 to 1 (e.g., between about 2.4 to 1 and about 2.5 to 1). The pressure is held at this level, while the cake travels over a straight nose collar section SNC formed by cylindrical member 128 and discharges the press through a cake outlet (not shown). The overall compression ratio of this shaft 100 is greater than about 7:1 and the final cake thickness is around 3/8″.

According to one example of the 12-10-4 shaft embodiment, the components have the following configuration. The feed quill member 102 has an axial length on the order of about twenty inches, a constant root diameter on the order of about 6 inches and a flight pitch of about 6 inches. The flight member 106 and spacer 108 have a combined axial length of between 9 and 10 inches, a starting root diameter of about 6 inches, an end root diameter of between 6.5 and 6.7 inches, and a flight pitch on member 108 of between 6.3 and 6.5 inches. The flight member 110 has an axial length of between 7.5 and 8.5 inches, a starting root diameter of between 6.5 and 6.7 inches, an end root diameter of between 7.2 and 7.3 inches and a flight pitch of between 5.15 and 5.3 inches. The flight member 112 has an axial length of between 6.6 and 7 inches, a starting root diameter of between 7.2 and 7.3 inches, an end root diameter of between 7.85 and 8 inches and a flight pitch of between 4.5 and 4.7 inches. The cone member 114 has an axial length of between 5 and 5.2 inches, a starting root diameter of between 7.85 and 8 inches and an end root diameter of between 8.3 and 8.5 inches. The flight member 120 reduced diameter portion 122 have a combined axial length of between 9 and 10 inches, a starting root diameter of between 7.1 and 7.3 inches, an end root diameter of between 7.6 and 7.75 inches and a flight pitch on member 120 of between 4.9 and 5.1 inches. The flight member 124 has an axial length of between 6.1 and 6.3 inches, a starting root diameter of between 7.6 and 7.75 inches, an end root diameter of between 7.9 and 8.1 inches and flight pitch of between 3.6 and 3.75 inches. The cone member 126 has an axial length of between 4.5 and 5 inches, a starting root diameter of between 7.9 and 8.1 inches and an end root diameter of between 9.1 and 9.3 inches. The cylindrical member 128 has a length of between 8 and 10 inches and a constant root diameter of between 9.1 and 9.3 inches.

### The 12-12-4 Shaft Configuration

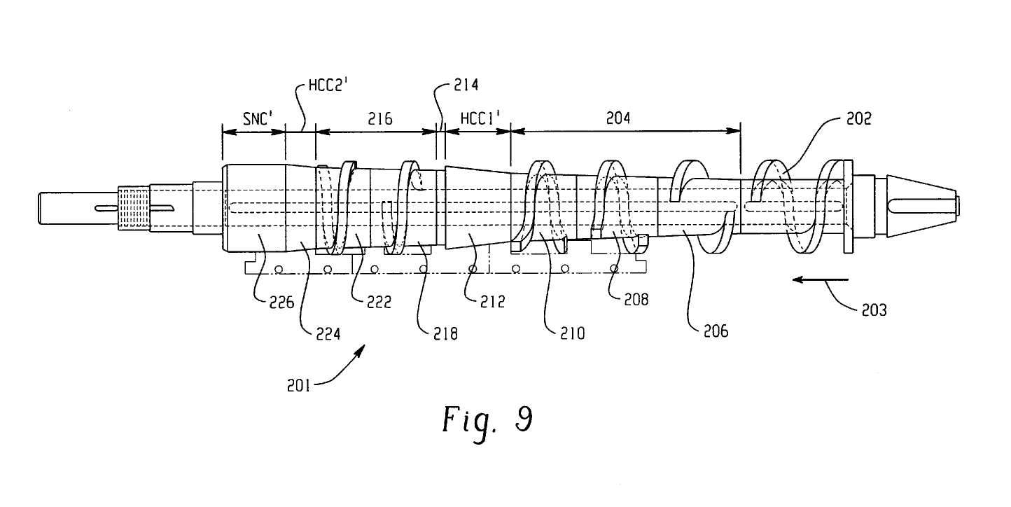

Referring to the exemplary 12-12-4 shaft 201 shown in FIG. 9, a 12″ diameter, two-thirds pitch feed quill 202 is used. The first approximately 58% of the shaft is configured like a traditional rendering shaft with scroll flights that gradually decrease the cake thickness by gradually increasing the flight's body diameter. This first section is important because it gradually compresses the cooked material to form a hardened plug, which doesn't extrude through the barrel bars, when it contacts the 1st high compression cone. Material flow direction during rotation of the shaft is right to left in FIG. 9 as shown by arrow 203.

By way of example, a first scroll flight section 204 made up of flight member 206, flight member 208 and flight member 210 may be configured for decreasing cake thickness by at least about 30% (e.g., between about 35% and about 40%) over a length of between about 24 inches and about 34 inches (e.g., between about 28 inches and about 30 inches) with a compression ratio of between about 1.5 to 1 and about 1.8 to 1 (e.g., between about 1.6 to 1 and between about 1.7 to 1). A first high compression cone section HCC1′, made up of cone member 212, is adjacent and downstream of the first scroll flight section 204. The first high compression cone section HCC1′ defines a compression ratio of between about 1.9 to 1 and about 2.5 to 1 (e.g., at least about 2.0 to 1) along a length of no more than about ten inches (e.g., no more than about 8.5 inches (e.g. between about 7.9 and about 8.1 inches). The material is abruptly decompressed (with a decompression ratio of at least about 1.3 to 1 (e.g. between about 1.35 to 1 and about 1.5 to 1)) at a stepped decompression section 214 after the cone member 212 and this pressure release is important, because it re-orients the material, so that further material compression will release more fat. The stepped decompression section 214 may be defined by a reduced diameter portion 220 formed integral with the cone member 212.

The cake then travels over a second scroll flight section 216 made up of flight member 218, and flight member 222, where the pressure is gradually increased (prior to a second high compression cone flight HCC2′) with a compression ratio of between about 1.4 to 1 and about 1.7 to 1 (e.g, between about 1.5 to 1 and about 1.6 to 1). At the second cone section HCC2′ formed by cone member 224, the pressure is increased with a compression ratio of between about 2.1 to 1 and about 2.4 to 1 (e.g., between about 2.2 to 1 and about 2.3 to 1). The pressure is held at this level, while the cake travels over a straight nose collar section SNC′ formed by cylindrical member 226 and discharges the press through a cake outlet (not shown). The overall compression ratio of this shaft 201 is greater than about 8:1 and the final cake thickness is around 3/8″.

According to one example of the 12-12-4 shaft embodiment, the components have the following configuration. The feed quill 202 has an axial length on the order of about 14 inches, a constant root diameter on the order of between 6.8 and 6.9 inches and a flight pitch of between 6.8 and 6.9 inches. The flight member 206 has an axial length of between 10 and 10.4 inches, a starting root diameter of between 6.8 and 6.9 inches, an end root diameter of between 7.4 and 7.65 inches, and a flight pitch of between 6.7 and 6.9 inches. The flight member 208 has an axial length of between 10 and 10.4 inches, a starting root diameter of between 7.4 and 7.65 inches, an end root diameter of between 8 and 8.2 inches and a flight pitch of between 6.7 and 6.9 inches. The flight member 210 has an axial length of between 8.1 and 8.4 inches, a starting root diameter of between 8 and 8.2 inches, an end root diameter of between 8.7 and 8 8.85 inches and a flight pitch of between 5.8 and 6.1 inches. The cone member 212 has an axial length of between 7.5 and 8.3 inches, a starting root diameter of between 8.7 and 8.85 inches and an end root diameter of between 10.5 and 10.65 inches. The flight member 218 and reduced diameter portion 220 have a combined axial length of between 8.5 and 9.5 inches, a starting root diameter of between 9.15 and 9.4 inches, an end root diameter of between 9.7 and 9.85 inches and a flight pitch on member 218 of between 4.7 and 4.85 inches. The flight member 222 has an axial length of between 6.7 and 6.95 inches, a starting root diameter of between 9.7 and 9.85 inches, an end root diameter of between 10.2 and 10.3 inches and flight pitch of between 4.5 and 4.65 inches. The cone member 224 has an axial length of between 3 and 4 inches, a starting root diameter of between 10.2 and 10.3 inches and an end root diameter of between 11.15 and 11.3 inches. The cylindrical member has an axial length of between 7 and 9 inches and a constant root diameter of between 11.15 and 11.3 inches.

In the foregoing descriptions, the “length to diameter ratio” of the shaft may be defined as the length of the working portion of the shaft that aligns with the main barrel cage of the screw press (e.g., typically the same as or slightly larger than the length of the main cage) over the outer diameter of the flights of the working portion of the shaft (e.g., typically the same as the diameter of the inner surface of the bars of the main barrel cage).

The “compression ratio” of a lengthwise portion of the shaft may be defined on a volumetric basis as the ratio of the expected material volume at the upstream end of the lengthwise portion of the shaft to the expected material volume at the downstream end of the lengthwise portion of the shaft. In each case the expected volumes are calculated as the applicable flight pitch times the annular cross sectional material flow area at the particular location (such area defined between the outer diameter of the flights on the working portion of the shaft (e.g., typically the same as the diameter of the inner surface of the bars of the main cage) and the diameter at the root of the shaft at the particular location). For example, and referring to FIG. 8 where the first scroll flight section 104 is made up of flight member 106, spacer 108, flight member 110 and flight member 112, the compression ratio along this lengthwise portion of the shaft would be calculated as Vol1/Vol2, where:

Vol1=3.14159*((10/2)²−(r1/2)²)*FP_{FlightMember106}; and

Vol2=3.14159*((10/2)²−(r2/2)²)*FP_{FlightMember112}; and

r1 is the starting root diameter for the flight member 106; and

r2 is the end root diameter for the flight member 112; and

FP_{FlightMember106} is the flight pitch for flight member 106; and

FP_{Flightmember112} is the flight pitch for flight member 112.

In the case of a cone that has no flight, the flight pitch of the immediately preceding flight is utilized to calculate the volumes.

The “cake thickness” associated with a specific position along the length of the shaft may be defined as the annular depth from the outer diameter of the flights on the working portion of the shaft (e.g., typically the same as the diameter of the inner surface of the bars of the main cage to the diameter at the root of the shaft at the specific position).

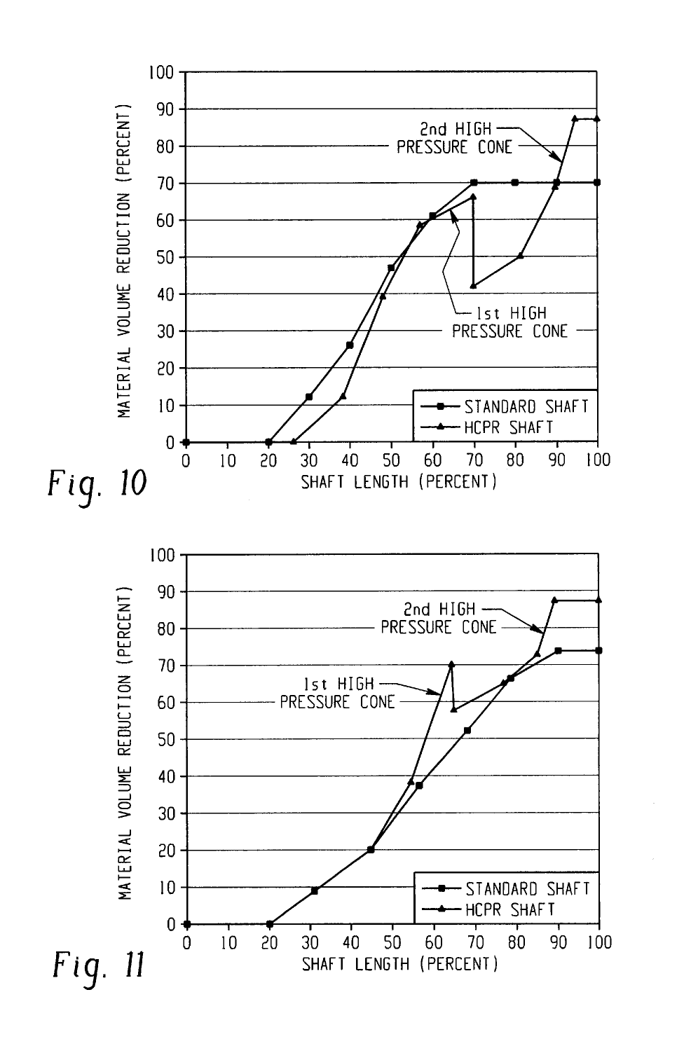

Notably, the high compression press release shaft described above provides advantages, including: (i) maintaining a length to diameter ratio of a Dupps standard rendering shaft, so that it can be installed into a standard Dupps Pressor® machine with a four foot long cage, (ii) having a compression ratio greater than about 7:1, which decreases the meal fat residual by about an additional 1%-2%, when compared to a standard Dupps rendering shaft on the same cooked material at the same press speed, and (iii) maintaining press throughput, when compared to a standard Dupps rendering shaft on the same cooked material at the same press speed. These advantages can be seen in relation to FIGS. 10 and 11, which show the greater material volume reduction achieved with each respective version of the high compression press release shaft.

All the high wear and high compression flights may be Dupps Tuff-Cast™ flights made from Dualloy. This Dupps' patented process for manufacturing bi-metallic hard surfaced flights casts a hard, wear-resistant surface over a softer core with a high-integrity, uniform bond. Tuff-Cast flights are virtually free of porosity and inclusions, resulting in a more durable, longer-lasting hard-facing layer.

The barrel cage sections of the press machines in which the high compression press release shafts are used may have a variety of different configurations. In one implementation, the barrel cage assembly includes an upstream section defined by first barrel bars of a first configuration and a downstream section defined by second barrel bars of a second configuration. For example, the upstream barrel bars may be 3/8″ wide (precision ground or not) and the downstream 1/2″ wide, or visa versa. In certain applications use of the different barrel bars in different axial sections of the cage provides a benefit and represents a unique advantage not utilized in the past. In another implementation all barrel bars in the cage have the same configuration (e.g., all 3/8″ wide precision ground, or all 3/8″ wide not precision ground or all 1/2″ wide).

Notably, in the Dupps Pressor machine, the material is not heated by any internal or external heating element as the material passes through the machine, though some heating due to friction will occur.

It is to be clearly understood that the above description is intended by way of illustration and example only, is not intended to be taken by way of limitation, and that other changes and modifications are possible.

What is claimed is:

1. A method of rendering liquid fat from animal protein, the method comprising:
heating the animal protein;
after the heating step, feeding the heated animal protein into a rendering screw press machine having an internal shaft assembly, the shaft assembly comprising:
a feed quill portion and a working portion, the working portion extending through a barrel cage of the rendering screw press machine, the working portion having:
a length to diameter ratio of between about 4 to 1 and about 5 to 1;
an overall compression ratio of greater than about 7 to 1;
a first scroll flight section including one or more scroll flights, the first scroll flight section configured for decreasing cake thickness by between about 35% and about 55% over a length of between about 20 inches to about 34 inches with a compression ratio of between about 1.6 to 1 and about 2.5 to 1;
a first high compression cone section adjacent and downstream of the first scroll flight section, the first high compression cone section defining a compression ratio of between about 1.2 to 1 and about 2.5 to 1 along a length of no more than about ten inches;
a stepped decompression section adjacent and downstream of the first high compression cone section and defining a stepped decompression ratio of at least about 1.4 to 1;
a second scroll flight section adjacent and downstream of the stepped decompression section, the second scroll flight section configured for decreasing cake thickness by between about 25% and about 40% with a compression ratio of between about 1.5 to 1 and about 1.9 to 1 over a length of between about 12 inches to about 18 inches;
a second high compression cone section adjacent and downstream of the second scroll flight section, the second high compression cone section defining a compression ratio of between about 2.1 to 1 and about 2.6 to 1; and
a straight collar section adjacent and downstream of the second high compression cone section and in part defining a choke opening for animal protein;
rotating the shaft assembly to move the heated animal protein through the rendering screw press machine such that liquid fat passes out through the barrel cage and substantially dried animal protein cake is output from the choke opening.

2. The method of claim 1 wherein for the working portion:
the first scroll flight section is configured for decreasing cake thickness by between about 45% and about 55% over a length of between about 20 inches to about 30 inches, where the compression ratio is between about 2.4 to 1 and about 2.5 to 1,
the compression ratio of the first high compression cone section is between about 1.2 to 1 and about 1.3 to 1 along a length of no more than about seven inches;
the stepped decompression ratio of the stepped decompression section is at least about 1.5 to 1;
the second scroll flight section is configured for decreasing cake thickness by between about 25% and about 35%, where the compression ratio is between about 1.8 to 1 and about 1.9 to 1;
the compression ratio of the second high compression cone section is between about 2.2 to 1 and about 2.6 to 1.

3. The method of claim 1 wherein for the working portion:
the overall compression ratio is greater than about 7 to 1;
the first scroll flight section is configured for decreasing cake thickness by between about 35% and about 40% over a length of between about 24 inches to about 34 inches, where the compression ratio is between about 1.6 to 1 and about 1.7 to 1;
the compression ratio of the first high compression cone section is between about 2 to 1 and about 2.5 to 1 along the length of no more than about ten inches;
the stepped decompression ratio of the stepped decompression section is at least about 1.4 to 1;
the second scroll flight section is configured for decreasing cake thickness by between about 30% and about 40%, where the compression ratio is between about 1.5 to 1 and about 1.6 to 1;
the compression ratio of the second high compression cone section is between about 2.1 to 1 and about 2.4 to 1

4. The method of claim 1 wherein heating of the animal protein by a heating element does not occur within the rendering screw press machine and the rendering screw press machine is a single screw shaft machine.

5. A method of rendering liquid fat from animal protein, the method comprising:
heating the animal protein;
after the heating step, feeding the heated animal protein into a rendering screw press machine having an internal shaft assembly, the shaft assembly comprising:
a feed quill portion and a working portion, the working portion extending through a barrel cage of the rendering screw press machine, the working portion having:
a length to diameter ratio of between about 4 to 1 and about 5 to 1;
an overall compression ratio of greater than about 7 to 1;
a first scroll flight section including one or more scroll flights, the first scroll flight section configured for decreasing cake thickness;
a first high compression cone section adjacent and downstream of the first scroll flight section;
a stepped decompression section adjacent and downstream of the first high compression cone section;
a second scroll flight section adjacent and downstream of the stepped decompression section, the second scroll flight section configured for decreasing cake thickness;
a second high compression cone section downstream of the second scroll flight section; and
a straight collar section adjacent and downstream of the second high compression cone section and in part defining a choke opening for animal protein;
rotating the shaft assembly to move the heated animal protein through the rendering screw press machine such that liquid fat passes out through the barrel cage and substantially dried animal protein cake is output from the choke opening, and the heated animal protein only undergoes one stepped decompression during such movement.

6. A shaft assembly for a rendering screw press machine, the shaft assembly comprising:
a feed quill portion and a working portion, the working portion having:
a length to diameter ratio of between about 4 to 1 and about 5 to 1;
an overall compression ratio of greater than about 7 to 1;
a first scroll flight section including one or more scroll flights, the first scroll flight section configured for decreasing cake thickness by between about 45% and about 55% over a length of between about 20 inches to about 30 inches with a compression ratio of between about 2.4 to 1 and about 2.5 to 1;
a first high compression cone section adjacent and downstream of the first scroll flight section, the first high compression cone section defining a compression ratio of between about 1.2 to 1 and about 1.3 to 1 along a length of no more than about seven inches;
a stepped decompression section adjacent and downstream of the first high compression cone section and defining a stepped decompression ratio of at least about 1.5 to 1;
a second scroll flight section adjacent and downstream of the stepped decompression section, the second scroll flight section configured for decreasing cake thickness by between about 25% and about 35% with a compression ratio of between about 1.8 to 1 and about 1.9 to 1 over a length of between about 12 inches to about 18 inches;
a second high compression cone section adjacent and downstream of the second scroll flight section, the second high compression cone section defining a compression ratio of between about 2.2 to 1 and about 2.6 to 1; and
a straight collar section adjacent and downstream of the second high compression cone section.

7. A rendering screw press machine including the shaft assembly of claim 6, comprising:
a main barrel cage assembly disposed around the working portion of the shaft assembly.

8. The rendering screw press machine of claim 7 wherein the main barrel cage assembly includes an upstream section defined by first barrel bars of a first configuration and a downstream section defined by second barrel bars of a second configuration.

9. The rendering screw press machine of claim 8, wherein the second barrel bars have a width that is different than a width of the first barrel bars.

10. The rendering screw press machine of claim 7 wherein the main barrel cage assembly includes barrel bars consisting of one common width.

11. A shaft assembly for a rendering screw press machine, the shaft assembly comprising:
a feed quill portion and a working portion, the working portion having:
a length to diameter ratio of between about 4 to 1 and about 5 to 1;
an overall compression ratio of greater than 8 to 1;
a first scroll flight section including one or more scroll flights, the first scroll flight section configured for decreasing cake thickness by between about 35% and about 40% with a compression ratio of between about 1.6 to 1 and about 1.7 to 1 over a length of between about 24 inches to about 34 inches;
a first high compression cone section adjacent and downstream of the first scroll flight section, the first high compression cone section defining a compression ratio of between about 2.0 to 1 and about 2.5 to 1 along a length of no more than about ten inches;
a stepped decompression section adjacent and downstream of the high compression cone section and defining a stepped decompression ratio of at least about 1.4 to 1;
a second scroll flight section adjacent and downstream of the stepped decompression section, the second scroll flight section configured for decreasing cake thickness by between about 30% and about 40% with a compression ratio of between about 1.5 to 1 and about 1.6 to 1 over a length of between about 12 inches to about 18 inches;
a second high compression cone section adjacent and downstream of the second scroll flight section, the second high compression cone section defining a compression ratio of between about 2.1 to 1 and about 2.4 to 1; and
a straight collar section adjacent and downstream of the second high compression cone section.

12. A rendering screw press machine including the shaft assembly of claim 11, comprising:
a main barrel cage assembly disposed around the working portion of the shaft assembly.

13. The rendering screw press machine of claim 12 wherein the main barrel cage assembly includes an upstream section defined by first barrel bars of a first configuration and a downstream section defined by second barrel bars of a second configuration.

14. The rendering screw press machine of claim 13, wherein the second barrel bars have a width that is different than a width of the first barrel bars.

15. The rendering screw press machine of claim 12 wherein the main barrel cage assembly includes barrel bars consisting of one common width.
